(19) United States
(12) Patent Application Publication
(10) Pub. No.: US 2024/0106693 A1
(43) Pub. Date: Mar. 28, 2024

(54) Global Internet Protocol Management System (GIMS) For Monitoring Network Devices for Fault Management

(71) Applicant: Level 3 Communications, LLC, Broomfield, CO (US)

(72) Inventors: Steve Toms, Middleburg, FL (US); David Sutton, Monroe, LA (US); William E. Curd, II, Littleton, CO (US); Wayne L. Williams, Littleton, CO (US); Binu Baby, Highlands Ranch, CO (US); Michael Ogden, Lakewood, CO (US); David Ho, Mercer Island, WA (US); Nashat Saqqa, Westminster, CO (US); Amer Khan, Erie, CO (US); Ranjith Kumar Nooka, Thornton, CO (US); Keith Sebesta, Saint Paul, MN (US); Tim W. Kimpton, Fort Smith, AR (US); Shelley Goldner, Superior, CO (US); Shelli L. Hurd, Arvada, CO (US)

(21) Appl. No.: 18/358,756

(22) Filed: Jul. 25, 2023

Related U.S. Application Data
(60) Provisional application No. 63/410,733, filed on Sep. 28, 2022.
(60) Provisional application No. 63/410,749, filed on Sep. 28, 2022.

(51) Int. Cl. H04L 41/0213; H04L 43/04

(52) U.S. Cl. CPC H04L 41/0213; H04L 43/04

(57) ABSTRACT

Novel tools and techniques are provided for implementing global Internet Protocol management system (“GIMS”) for monitoring network devices for fault management. In various embodiments, a computing system may receive a first alert associated with a first device among layer 2 and/or layer 3 devices disposed in a plurality of networks; may collect first alert data and/or first device data; may store the first alert together with the collected first alert data and/or first device data as first consolidated alert data in a first database; may perform, using an enrichment system, enrichment of the first alert, by retrieving first enrichment data from one or more second databases and adding the first enrichment data to the first consolidated alert data in the first database; and may send the first consolidated alert data to a fault management system for display to a user to facilitate addressing of the first alert by the user.

### CROSS-REFERENCES TO RELATED APPLICATIONS

This application claims priority to U.S. Patent Application Ser. No. 63/410,733 (the “'733 Application”), filed Sep. 28, 2022, by Steve Toms et al. (attorney docket no. 1726-US-P1), entitled, “Global Internet Protocol Management System (GIMS) for Monitoring Network Devices for Fault Management,” and U.S. Patent Application Ser. No. 63/410,749 (the “'749 Application”), filed Sep. 28, 2022, by Steve Toms et al. (attorney docket no. 1726-US-P2), entitled, “Software-Based Network Probes for Monitoring Network Devices for Fault Management,” the disclosure of each of which is incorporated herein by reference in its entirety for all purposes.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing network management, and, more particularly, to methods, systems, and apparatuses for implementing global Internet Protocol management system (“GIMS”) for monitoring network devices for fault management.

### BACKGROUND

Conventional network management systems are unable to handle all aspects of fault management. In the context of monitoring for faults, conventional network management systems only handle aspects of monitoring (e.g., only passive monitoring, only active polling, only pinging, and/or the like) network devices, but either do not utilize a broader suite of collection modalities and/or do not normalize alerts and/or do not enrich alerts with customer or other information, or the like, thereby resulting in incomplete information being presented to users or technicians, which prolongs resolution of network faults, requires further information gathering by the users or technicians, prolongs impact to the network and users or customers of network services, and so on.

Hence, there is a need for more robust and scalable solutions for implementing network management, and, more particularly, to methods, systems, and apparatuses for implementing GIMS for monitoring network devices for fault management.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components. For denoting a plurality of components, the suffixes “a” through “n,” where n denotes any suitable integer number, and may be either the same or different from the suffix “n” for other components in the same or different figures. For example, for component #1 105a-105n, the integer value of n in 105n may be the same or different from the integer value of n in 110n for component #2 110a-110n, and so on.

FIG. 1 is a schematic diagram illustrating a system for implementing global Internet Protocol management system (“GIMS”) for monitoring network devices for fault management, in accordance with various embodiments.

FIGS. 2A and 2B are diagrams illustrating a non-limiting example of a network fault in a global context that may be monitored during implementation of GIMS for monitoring network devices for fault management, in accordance with various embodiments.

FIGS. 3A-3F are diagrams illustrating various non-limiting examples of a user interface (“UI”) that may be presented on a user device used by a user and may be used for searching and validating networks and their components based on data monitored during implementation of GIMS for monitoring network devices for fault management, in accordance with various embodiments.

FIGS. 4A-4C are flow diagrams illustrating a method for implementing GIMS for monitoring network devices for fault management, in accordance with various embodiments.

FIG. 5 is a block diagram illustrating an exemplary computer or system hardware architecture, in accordance with various embodiments.

### DETAILED DESCRIPTION OF CERTAIN EMBODIMENTS

### Overview

Various embodiments provide tools and techniques for implementing network management, and, more particularly, to methods, systems, and apparatuses for implementing global Internet Protocol management system (“GIMS”) for monitoring network devices for fault management.

In various embodiments, a computing system may receive a first alert associated with a first device among at least one of a plurality of layer 2 devices or a plurality of layer 3 devices that are each disposed within at least one network among a plurality of networks, the layer 2 devices and the layer 3 devices corresponding to open systems interconnection (“OSI”) model's data link layer and network layer, respectively; may collect at least one of first alert data associated with the first alert or first device data associated with the first device; may store the first alert together with the collected at least one of the first alert data or the first device data as first consolidated alert data in a first database; may perform, using an enrichment system, enrichment of the first alert, by: retrieving first enrichment data from one or more second databases, the first enrichment data comprising at least one of service data associated with a service provided via the first device to a customer, customer data corresponding to the customer associated with the service provided via the first device or associated with the first device, or network data associated with a network in which the first device is disposed; and adding the first enrichment data to the first consolidated alert data in the first database; and may send the first consolidated alert data to a fault management system for display to a user to facilitate addressing of the first alert by the user.

In some embodiments, the computing system may comprise at least one of a global Internet Protocol management system (“GIMS”), the fault management system, a network operations center (“NOC”) computing system, a server over a network, a cloud computing system, or a distributed computing system, and/or the like. In some instances, the plurality of networks may comprise two or more disparate networks utilizing different alert management protocols and different fault management protocols. The network devices in each network may themselves also utilize different types of alerts, different alert formats, different alert modalities, etc. In some cases, the first database may comprise at least one of a remote dictionary server (“Redis”) database, a non-relational (“NoSQL”) database, or a relational (“SQL”) database, and/or the like. In some instances, the first consolidated alert data may comprise real-time or near-real-time consolidated alert data, and the fault management system may comprise a real-time fault management system (“RFM”) that displays the real-time or near-real-time consolidated alert data.

According to some embodiments, the computing system may normalize the first consolidated alert data relative to a plurality of consolidated alert data that is stored in the first database. In some embodiments, the computing system may perform, using an alert manager, field mapping of the first consolidated alert data using the first enrichment data; and may provide, using the alert manager, the field mapped first consolidated alert data to a single alert queue within the first database. According to some embodiments, the computing system may provide a GIMS user interface (“UI”) to the user. In some cases, the GIMS UI may comprise at least one of a search tool configured to search for devices among the at least one of the plurality of layer 2 devices or the plurality of layer 3 devices, a reporting tool configured to produce reports associated with one or more devices among the at least one of the plurality of layer 2 devices or the plurality of layer 3 devices, or a system monitoring tool configured to provide the user with options for selecting types of device information and thresholds for monitoring functionality and status of devices among the at least one of the plurality of layer 2 devices or the plurality of layer 3 devices, and/or the like.

According to the various embodiments, the computing system or GIMS provides functionalities or features of receiving and normalizing (and, in some cases, enriching) alerts for and/or from network devices (particularly, layer 2 devices and/or layer 3 devices corresponding to OSI model's data link layer and network layer, or the like; which may utilize different types of alerts, different alert formats, different alert modalities, and/or the like) that are disposed in one or more disparate networks utilizing different alert management protocols and different fault management protocols, and to send the alert data to a fault management system (e.g., RFM, or the like) for display to a user to facilitate addressing of the alert by the user (e.g., technicians who add or remove network devices and/or people who need access to such network devices, as listed or identified by NOC managers, or the like). The result is a robust monitoring system that collects, normalizes, enriches, and displays relevant information about alerts related to network device faults, thereby greatly facilitating the user in addressing the alerts, which shortens time for resolution of network faults, obviates further information gathering by the users or technicians, reduces impact to the network and users or customers of network services, and so on. In this manner, the functioning and/or operation of the affected network devices and the network as a whole may be improved, at least in terms of improving the field of network management, by at least normalizing and enriching alerts from disparate network devices (utilizing different types of alerts, different alert formats, different alert modalities, and/or the like) disposed in disparate networks (utilizing different alert management protocols and different fault management protocols), and/or the like.

These and other aspects of the GIMS for monitoring network devices for fault management are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

In an aspect, a method may comprise receiving, using a computing system, a first alert associated with a first device among at least one of a plurality of layer 2 devices or a plurality of layer 3 devices that are each disposed within at least one network among a plurality of networks, the layer 2 devices and the layer 3 devices corresponding to open systems interconnection (“OSI”) model's data link layer and network layer, respectively. The method may also comprise collecting, using the computing system, at least one of first alert data associated with the first alert or first device data associated with the first device; storing, using the computing system, the first alert together with the collected at least one of the first alert data or the first device data as first consolidated alert data in a first database; and performing, using the computing system and an enrichment system, enrichment of the first alert, by: retrieving first enrichment data from one or more second databases, the first enrichment data comprising at least one of service data associated with a service provided via the first device to a customer, customer data corresponding to the customer associated with the service provided via the first device or associated with the first device, or network data associated with a network in which the first device is disposed; and adding the first enrichment data to the first consolidated alert data in the first database. The method may further comprise sending, using the computing system, the first consolidated alert data to a fault management system for display to a user to facilitate addressing of the first alert by the user.

In some embodiments, the computing system may comprise at least one of a global Internet Protocol management system (“GIMS”), the fault management system, a network operations center (“NOC”) computing system, a server over a network, a cloud computing system, or a distributed computing system, and/or the like. In some instances, the plurality of networks may comprise two or more disparate networks utilizing different alert management protocols and different fault management protocols. In some cases, the first database may comprise at least one of a remote dictionary server (“Redis”) database, a non-relational (“NoSQL”) database, or a relational (“SQL”) database, and/or the like. In some instances, the first consolidated alert data may comprise real-time or near-real-time consolidated alert data, and the fault management system may comprise a real-time fault management system (“RFM”) that displays the real-time or near-real-time consolidated alert data.

According to some embodiments, collecting the at least one of the first alert data or the first device data may comprise at least one of: receiving, using the computing system, at least one of the first alert data or the first device data from the first device via one of one or more simple network management protocol (“SNMP”) trap messages or one or more system logging protocol (“Syslog”) messages; polling, using the computing system and a polling engine, one or more second devices among the at least one of the plurality of layer 2 devices or the plurality of layer 3 devices for at least one of alert data or device data, the one or more second devices including the first device; pinging, using the computing system, the first device to determine whether the first device is responsive, wherein the first alert data comprises data indicating when the first device is not responsive, wherein the first device data comprises data corresponding to responsiveness or lack of responsiveness of the first device; pulling, using the computing system, at least one of the first alert data or the first device data from the first device; checking, using the computing system, a status of physical equipment, the status of physical equipment comprising at least one of status data indicating that the first device is not functioning within predetermined device parameters, status data indicating that a fan or other cooling device at the location of the first device is not functioning within predetermined cooling parameters, status data indicating that an interface is not functioning within predetermined interface parameters, status data indicating that a power supply is not functioning within predetermined power supply parameters, or status data flagging one or more errored seconds indicative of one or more intervals of a second during which an error occurred; discovering, using the computing system and a discovery engine, one or more third devices including the first device, wherein discovering the one or more third devices comprises receiving at least one of alert data or device data from each of the one or more third devices; or retrieving, using the computing system, the at least one of the first alert data or the first device data associated with the first device from a seed table that tracks known devices among the at least one of the plurality of layer 2 devices or the plurality of layer 3 devices; and/or the like. In some instances, the one or more SNMP trap messages may be processed, modified, or deleted by a SNMP manager, based on first independent rules associated with the network in which the first device is disposed, prior to storing the first alert in the first database. Similarly, the one or more Syslog messages may be processed, modified, or deleted by a Syslog server, based on second independent rules associated with the network in which the first device is disposed, prior to storing the first alert in the first database.

In some embodiments, the method may further comprise normalizing, using the computing system, the first consolidated alert data relative to a plurality of consolidated alert data that is stored in the first database.

According to some embodiments, the method may further comprise performing, using the computing system and an alert manager, field mapping of the first consolidated alert data using the first enrichment data; and providing, using the computing system and the alert manager, the field mapped first consolidated alert data to a single alert queue within the first database.

In some embodiments, the method may further comprise providing, using the computing system, a GIMS user interface (“UI”) to the user. In some cases, the GIMS UI may comprise at least one of a search tool configured to search for devices among the at least one of the plurality of layer 2 devices or the plurality of layer 3 devices, a reporting tool configured to produce reports associated with one or more devices among the at least one of the plurality of layer 2 devices or the plurality of layer 3 devices, or a system monitoring tool configured to provide the user with options for selecting types of device information and thresholds for monitoring functionality and status of devices among the at least one of the plurality of layer 2 devices or the plurality of layer 3 devices, and/or the like.

In another aspect, a system may comprise a computing system, which may comprise at least one first processor and a first non-transitory computer readable medium communicatively coupled to the at least one first processor. The first non-transitory computer readable medium may have stored thereon computer software comprising a first set of instructions that, when executed by the at least one first processor, causes the computing system to: receive a first alert associated with a first device among at least one of a plurality of layer 2 devices or a plurality of layer 3 devices that are each disposed within at least one network among a plurality of networks, the layer 2 devices and the layer 3 devices corresponding to open systems interconnection (“OSI”) model's data link layer and network layer, respectively; collect at least one of first alert data associated with the first alert or first device data associated with the first device; store the first alert together with the collected at least one of the first alert data or the first device data as first consolidated alert data in a first database; perform, using an enrichment system, enrichment of the first alert, by: retrieving first enrichment data from one or more second databases, the first enrichment data comprising at least one of service data associated with a service provided via the first device to a customer, customer data corresponding to the customer associated with the service provided via the first device or associated with the first device, or network data associated with a network in which the first device is disposed; and adding the first enrichment data to the first consolidated alert data in the first database; and send the first consolidated alert data to a fault management system for display to a user to facilitate addressing of the first alert by the user.

According to some embodiments, the computing system may comprise at least one of a global Internet Protocol management system (“GIMS”), the fault management system, a network operations center (“NOC”) computing system, a server over a network, a cloud computing system, or a distributed computing system, and/or the like. In some instances, the plurality of networks may comprise two or more disparate networks utilizing different alert management protocols and different fault management protocols. In some cases, the first database may comprise at least one of a remote dictionary server (“Redis”) database, a non-relational (“NoSQL”) database, or a relational (“SQL”) database, and/or the like. In some instances, the first consolidated alert data may comprise real-time or near-real-time consolidated alert data, and the fault management system may comprise a real-time fault management system (“RFM”) that displays the real-time or near-real-time consolidated alert data.

In some embodiments, collecting the at least one of the first alert data or the first device data may comprise at least one of: receiving at least one of the first alert data or the first device data from the first device via one of one or more simple network management protocol (“SNMP”) trap messages or one or more system logging protocol (“Syslog”) messages; polling, using a polling engine, one or more second devices among the at least one of the plurality of layer 2 devices or the plurality of layer 3 devices for at least one of alert data or device data, the one or more second devices including the first device; pinging the first device to determine whether the first device is responsive, wherein the first alert data comprises data indicating when the first device is not responsive, wherein the first device data comprises data corresponding to responsiveness or lack of responsiveness of the first device; pulling at least one of the first alert data or the first device data from the first device; checking a status of physical equipment, the status of physical equipment comprising at least one of status data indicating that the first device is not functioning within predetermined device parameters, status data indicating that a fan or other cooling device at the location of the first device is not functioning within predetermined cooling parameters, status data indicating that an interface is not functioning within predetermined interface parameters, status data indicating that a power supply is not functioning within predetermined power supply parameters, or status data flagging one or more errored seconds indicative of one or more intervals of a second during which an error occurred; discovering, using a discovery engine, one or more third devices including the first device, wherein discovering the one or more third devices comprises receiving at least one of alert data or device data from each of the one or more third devices; or retrieving the at least one of the first alert data or the first device data associated with the first device from a seed table that tracks known devices among the at least one of the plurality of layer 2 devices or the plurality of layer 3 devices; and/or the like. In some instances, the one or more SNMP trap messages may be processed, modified, or deleted by a SNMP manager, based on first independent rules associated with the network in which the first device is disposed, prior to storing the first alert in the first database. Similarly, the one or more Syslog messages may be processed, modified, or deleted by a Syslog server, based on second independent rules associated with the network in which the first device is disposed, prior to storing the first alert in the first database.

According to some embodiments, the first set of instructions, when executed by the at least one first processor, may further cause the computing system to: normalize the first consolidated alert data relative to a plurality of consolidated alert data that is stored in the first database.

In some embodiments, the first set of instructions, when executed by the at least one first processor, may further cause the computing system to: perform, using an alert manager, field mapping of the first consolidated alert data using the first enrichment data; and provide, using the alert manager, the field mapped first consolidated alert data to a single alert queue within the first database.

According to some embodiments, the first set of instructions, when executed by the at least one first processor, may further cause the computing system to: provide a GIMS user interface (“UI”) to the user. In some cases, the GIMS UI may comprise at least one of a search tool configured to search for devices among the at least one of the plurality of layer 2 devices or the plurality of layer 3 devices, a reporting tool configured to produce reports associated with one or more devices among the at least one of the plurality of layer 2 devices or the plurality of layer 3 devices, or a system monitoring tool configured to provide the user with options for selecting types of device information and thresholds for monitoring functionality and status of devices among the at least one of the plurality of layer 2 devices or the plurality of layer 3 devices, and/or the like.

In yet another aspect, a system may comprise a global Internet Protocol management system (“GIMS”), comprising: a simple network management protocol (“SNMP”) manager configured to receive SNMP trap messages from network devices; a system logging protocol (“Syslog”) server configured to receive Syslog messages from network devices; an alert manager configured to manage alerts associated with network devices; at least one of a polling engine, a discovery engine, or a seed processor, the polling engine being configured to poll network devices for at least one of alert data or device data, the discovery engine being configured to discover currently active or currently connected network devices on one or more networks, and the seed processor being configured to track network devices in the one or more networks; and an enrichment system configured to retrieve enrichment data from one or more second databases and to add enrichment data to consolidated alert data. In some instances, one or more of the GIMS, the SNMP manager, the Syslog server, the alert manager, or the at least one of the polling engine, the discovery engine, or the seed processor may be configured or further configured to: receive a first alert associated with a first device among at least one of a plurality of layer 2 devices or a plurality of layer 3 devices that are each disposed within at least one network among the one or more networks, the layer 2 devices and the layer 3 devices corresponding to open systems interconnection (“OSI”) model's data link layer and network layer, respectively; collect at least one of first alert data associated with the first alert or first device data associated with the first device; and store the first alert together with the collected at least one of the first alert data or the first device data as first consolidated alert data in a first database. In some cases, the enrichment system is further configured to perform enrichment of the first alert, by: retrieving first enrichment data from one or more second databases, the first enrichment data comprising at least one of service data associated with a service provided via the first device to a customer, customer data corresponding to the customer associated with the service provided via the first device or associated with the first device, or network data associated with a network in which the first device is disposed; and adding the first enrichment data to the first consolidated alert data in the first database. In some instances, at least one of the GIMS or the alert manager is further configured to: send the first consolidated alert data to a fault management system for display to a user to facilitate addressing of the first alert by the user.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

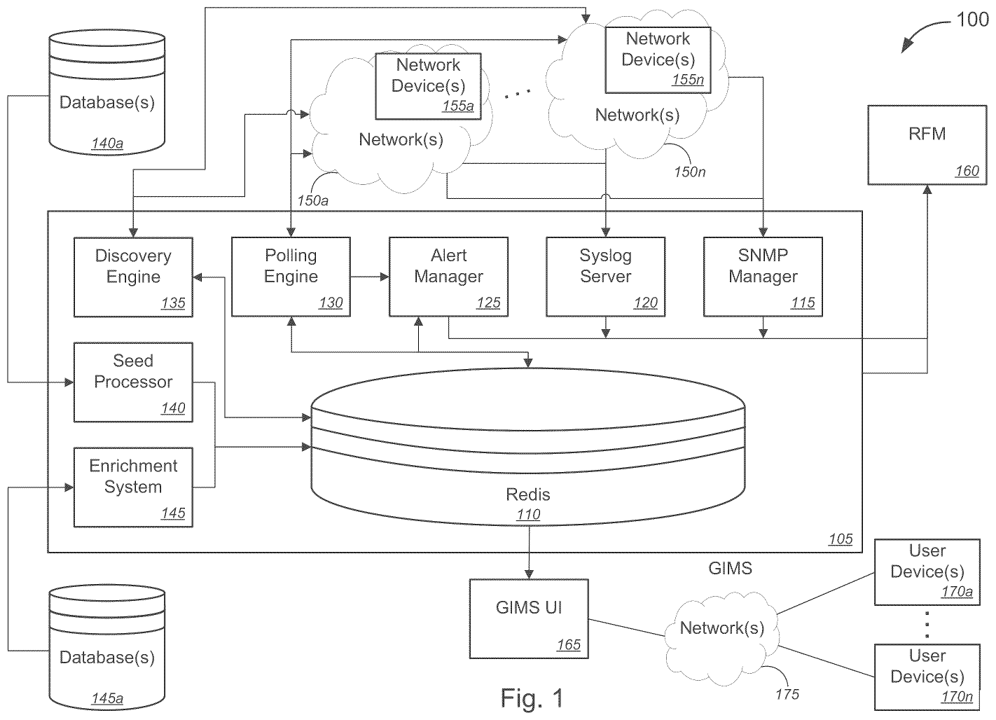

We now turn to the embodiments as illustrated by the drawings. FIGS. 1-5 illustrate some of the features of the method, system, and apparatus for implementing network management, and, more particularly, to methods, systems, and apparatuses for implementing global Internet Protocol management system (“GIMS”) for monitoring network devices for fault management, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 is a schematic diagram illustrating a system 100 for implementing GIMS for monitoring network devices for fault management, in accordance with various embodiments.

In the non-limiting embodiment of FIG. 1, system 100 may comprise a computing system and/or GIMS 105, which is a system that is configured to receive and normalize (and, in some cases, enrich) alerts for and/or from network devices (particularly, layer 2 devices and/or layer 3 devices corresponding to open systems interconnection (“OSI”) model's data link layer and network layer, or the like) that are disposed in one or more disparate networks, and to send the alert data to a fault management system (e.g., real-time fault management system (“RFM”) 160, or the like) for display to a user to facilitate addressing of the alert by the user. In some cases, the users may include, without limitation, technicians who add or remove network devices and/or people who need access to such network devices, as listed or identified by network operations center (“NOC”) managers, or the like.

In some embodiments, the computing system or GIMS 105 may include, without limitation, one or more of at least one first database 110; a simple network management protocol (“SNMP”) manager 115 configured to receive SNMP trap messages from network devices; a system logging protocol (“Syslog”) server 120 configured to receive Syslog messages from network devices; an alert manager 125 configured to manage alerts associated with and/or from network devices; at least one of a polling engine 130, a discovery engine 135, or a seed processor 140, and/or the like, the polling engine 130 being configured to poll network devices for at least one of alert data or device data, the discovery engine 135 being configured to discover currently active or currently connected network devices on one or more networks, and the seed processor 140 being configured to track known or newly identified/discovered network devices in the one or more networks, e.g., by comparing a list of devices from a source database(s) (e.g., database(s) 140a, or the like) with devices already listed in the at least one first database 110, and updating the list in the at least one first database 110 (e.g., by adding new devices, or the like); and an enrichment system 145 configured to retrieve enrichment data from one or more second databases (e.g., database(s) 145a, or the like) and to add enrichment data to alerts or to consolidated alert data associated with the alerts. These various processes, features, and/or functionalities of the GIMS 105 are performed autonomously with minimal if any input from the user (except for selection or entry of items to query, or the like).

System 100 may further comprise a plurality of networks 150a-150n (collectively, “networks 150” or the like), one or more network devices 155a-155n (collectively, “network devices 155” or the like) that are located or disposed in the networks 150, RFM 160, a GIMS user interface (“UI”) 165, one or more user devices 170a-170n (collectively, “user devices 170” or the like) associated with or used by one or more users (as described above), or one or more networks (or access networks) 175 that provide the user devices 170 with access to the GIMS UI 165, and/or the like. In some cases, the plurality of networks 150 may include, but is not limited to, two or more disparate networks utilizing different alert management protocols and different fault management protocols. In some embodiments, the components of the GIMS 105 (as well as the GIMS UI 165) may be implemented using virtual machine implementations (including, but not limited to, Docker® containers, or the like). In some instances, deployment tools may utilize Github® repositories and/or Ansible® distribution, and/or the like. In some cases, automated redundancy may be implemented, by using, e.g., Docker Swarm®, Kubernetes®, or other similar tools, and/or the like. In some instances, although not shown, GIMS UI 165 may further include without limitation, at least one of an administration UI or a configuration UI.

According to some embodiments, the computing system may include (or further include), but is not limited to, at least one of a fault management system, a NOC computing system, a server over a network, a cloud computing system, or a distributed computing system, and/or the like. In some instances, the first database 110 may include, but is not limited to, at least one of a remote dictionary server (“Redis”) database 110, a non-relational (“NoSQL”) database, or a relational (or structured query language (“SQL”)) database, and/or the like. In some embodiments, the Redis database may be a non-relational (or “non-SQL” or “NoSQL”) database that is also an in-memory data structure store that may be used as a distributed, in-memory key-value database, cache, and message broker, and supports different types of abstract data structures, including, but not limited to, at least one of strings, lists, maps, sets, sorted sets, HyperLogLogs, bitmaps, streams, or spatial indices, and/or the like. In the various embodiments, the Redis database may be used as one or more Redis queues. In some cases, the fault management system may include, without limitation, RFM 160, which is configured to display real-time or near-real-time consolidated alert data. In some instances, the one or more network devices 155 may each include, without limitation, at least one of a layer 2 switch or network switch (e.g., an Ethernet switch or other media access control (“MAC”) address-based network switch, or the like), a layer 2 network hub (e.g., an Ethernet hub or other MAC-based network switch, or the like), a bridge, a modem, a network card, an access point, a layer 3 switch or network switch (e.g., an Internet Protocol (“IP”) address-based network switch, or the like), or a router, and/or the like. In some cases, the one or more user devices 170 may each include, but is limited to, one of a desktop computer, a laptop computer, a tablet computer, a smart phone, a mobile phone, a NOC computing system or console, or any suitable device capable of communicating with computing system or GIMS 105 (or with GIMS UI 165) via a web-based portal, an application programming interface (“API”), a server, a software application (“app”), or any other suitable communications interface, or the like, over network(s) 175.

In some embodiments, network(s) 150 and/or 175 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 150 and/or 175 may include an access network of the service provider (e.g., an Internet service provider (“ISP”)). In another embodiment, the network(s) 150 and/or 175 may include a core network of the service provider and/or the Internet.

In operation, one or more of the computing system or GIMS 105, the SNMP manager 115, the Syslog server 120, the alert manager 125, or the at least one of the polling engine 130, the discovery engine 135, or the seed processor 140, and/or the like, may be configured or further configured to: receive a first alert associated with a first device among at least one of a plurality of layer 2 devices or a plurality of layer 3 devices (e.g., the one or more network devices 155a-155n, or the like) that are each disposed within at least one network among the one or more networks 150a-150n, the layer 2 devices and the layer 3 devices corresponding to OSI model's data link layer and network layer, respectively; collect at least one of first alert data associated with the first alert or first device data associated with the first device; and store the first alert together with the collected at least one of the first alert data or the first device data as first consolidated alert data in a first database (e.g., Redis database 110, or the like). In some instances, the first consolidated alert data may include real-time or near-real-time consolidated alert data, or the like.

In some cases, the enrichment system 145 may be further configured to perform enrichment of the first alert, by: retrieving first enrichment data from one or more second databases (e.g., database(s) 145a, or the like), the first enrichment data including, but not limited to, at least one of service data associated with a service provided via the first device to a customer, customer data corresponding to the customer associated with the service provided via the first device or associated with the first device, or network data associated with a network in which the first device is disposed, and/or the like; and adding the first enrichment data to the first consolidated alert data in the first database (e.g., Redis database 110, or the like). In some instances, at least one of the computing system or GIMS 105 or the alert manager 125 may be further configured to: send the first consolidated alert data to a fault management system (e.g., RFM 160, or the like) for display to a user to facilitate addressing of the first alert by the user.

In some embodiments, at least one of the computing system or GIMS 105 or the alert manager 125 may be further configured to: normalize the first consolidated alert data relative to a plurality of consolidated alert data that is stored in the first database (e.g., Redis database 110, or the like). According to some embodiments, at least one of the computing system or GIMS 105 or the alert manager 125 may be further configured to: perform field mapping of the first consolidated alert data using the first enrichment data; and provide the field mapped first consolidated alert data to a single alert queue within the first database (e.g., Redis database 110, or the like). In some embodiments, the computing system or GIMS 105 may be further configured to: provide the GIMS UI 165 to the user, in some cases, by providing a user device among the one or more user devices 170a-170n that is associated with or used by the user with access to the GIMS UI 165 via network(s) 175. In some cases, the GIMS UI may include, without limitation, at least one of a search tool configured to search for devices among the at least one of the plurality of layer 2 devices or the plurality of layer 3 devices (e.g., the one or more network devices 155, or the like), a reporting tool configured to produce reports associated with one or more devices among the at least one of the plurality of layer 2 devices or the plurality of layer 3 devices (e.g., the one or more network devices 155, or the like), or a system monitoring tool configured to provide the user with options for selecting types of device information and thresholds for monitoring functionality and status of devices among the at least one of the plurality of layer 2 devices or the plurality of layer 3 devices (e.g., the one or more network devices 155, or the like), and/or the like.

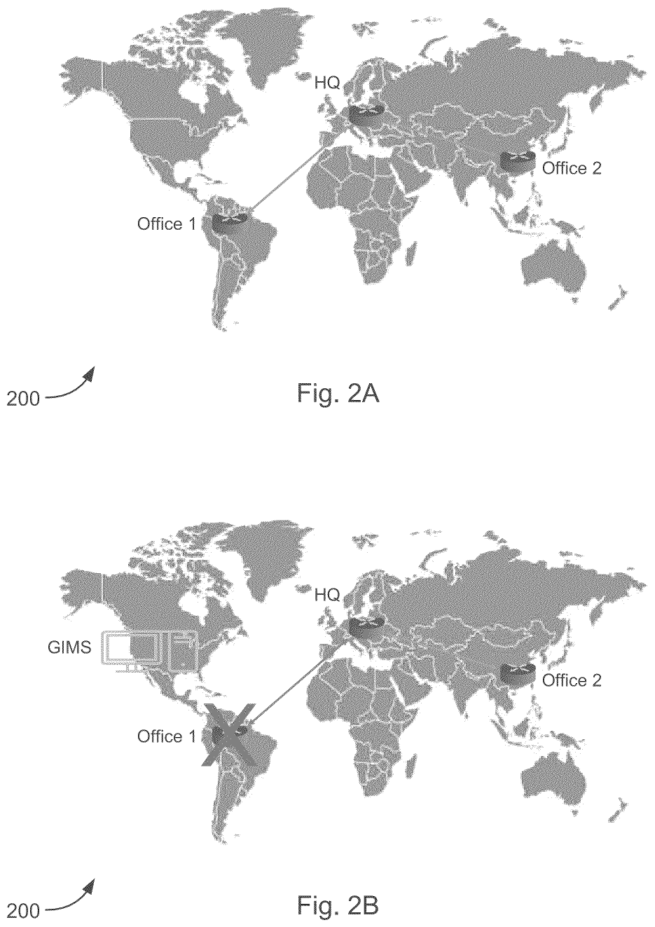

These and other functions of the system 100 (and its components) are described in greater detail below with respect to FIGS. 2-4.

FIGS. 2A and 2B (collectively, “FIG. 2”) are diagrams illustrating a non-limiting example 200 of a network fault in a global context that may be monitored during implementation of GIMS for monitoring network devices for fault management, in accordance with various embodiments.

As shown in the non-limiting example 200 of FIG. 2, a company or entity whose headquarters (“HQ” in FIG. 2) is in Europe may have an office, data center, and/or network devices in South America (“Office 1” in FIG. 2) and in China (“Office 2” in FIG. 2). If and when Office 1 is no longer functioning or encounters other network device faults (as denoted in FIG. 2B by the “X” and the dark gray double-headed arrow between HQ and Office 1, or the like), GIMS may be used to monitor and collect the alerts, to normalize the alerts, to enrich the alerts, and to send the alerts to a fault management system (e.g., RFM 160 of FIG. 1, or the like) for a user or technician to address the alert.

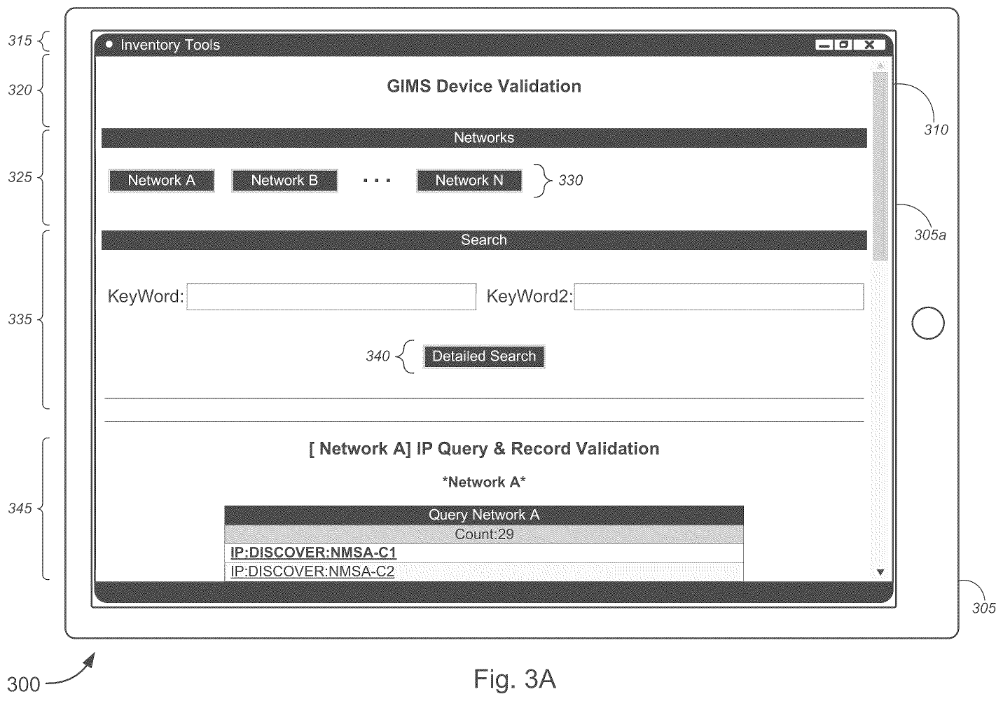

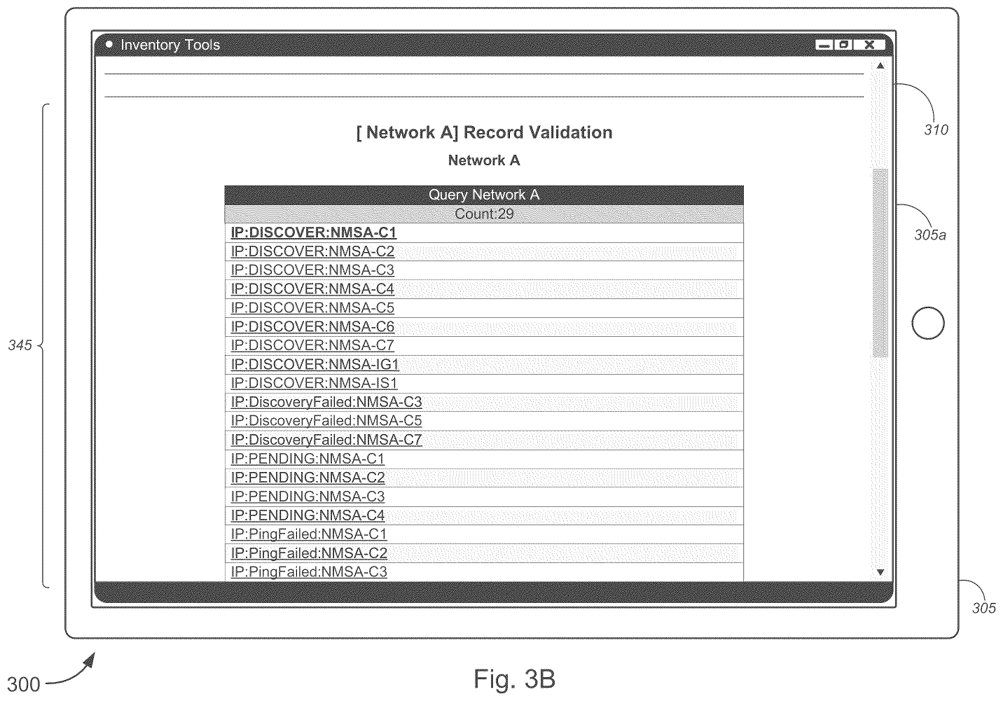

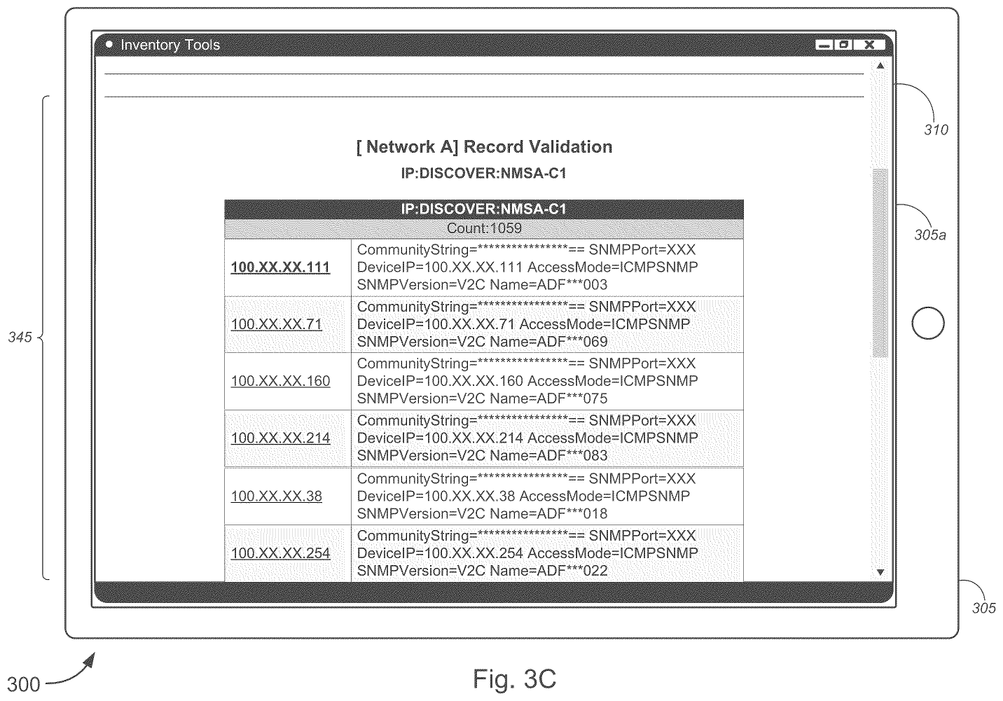

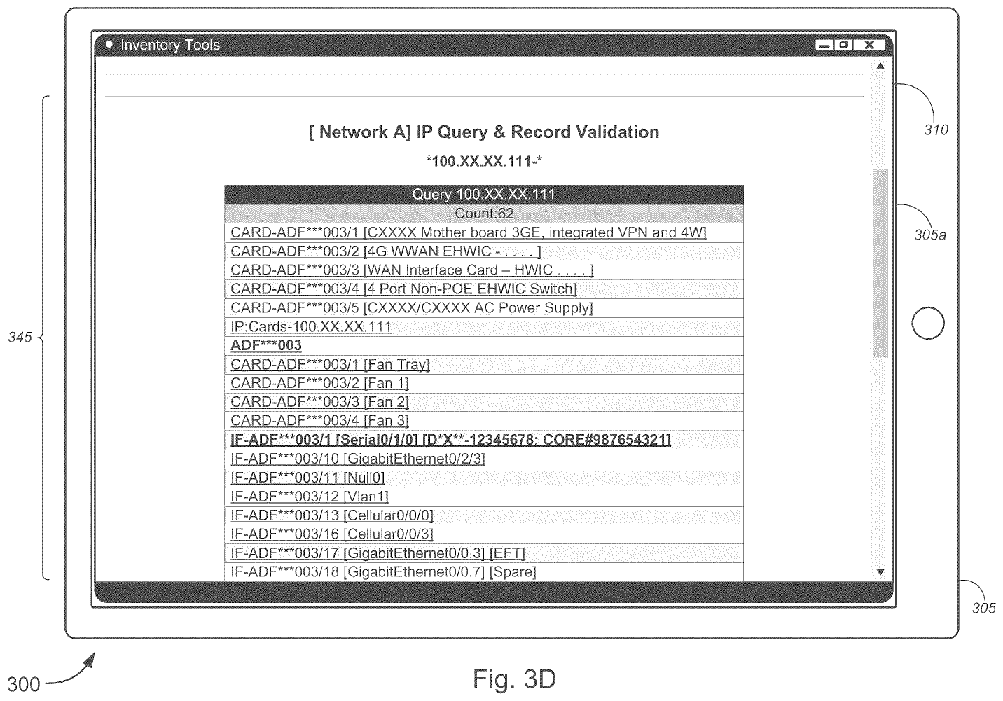

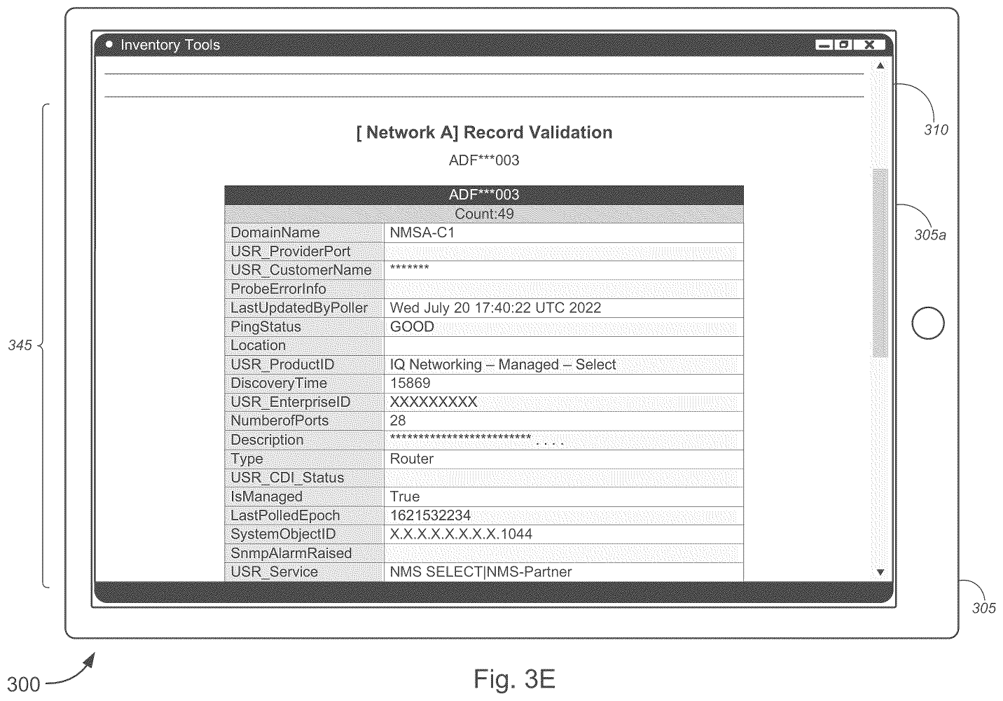

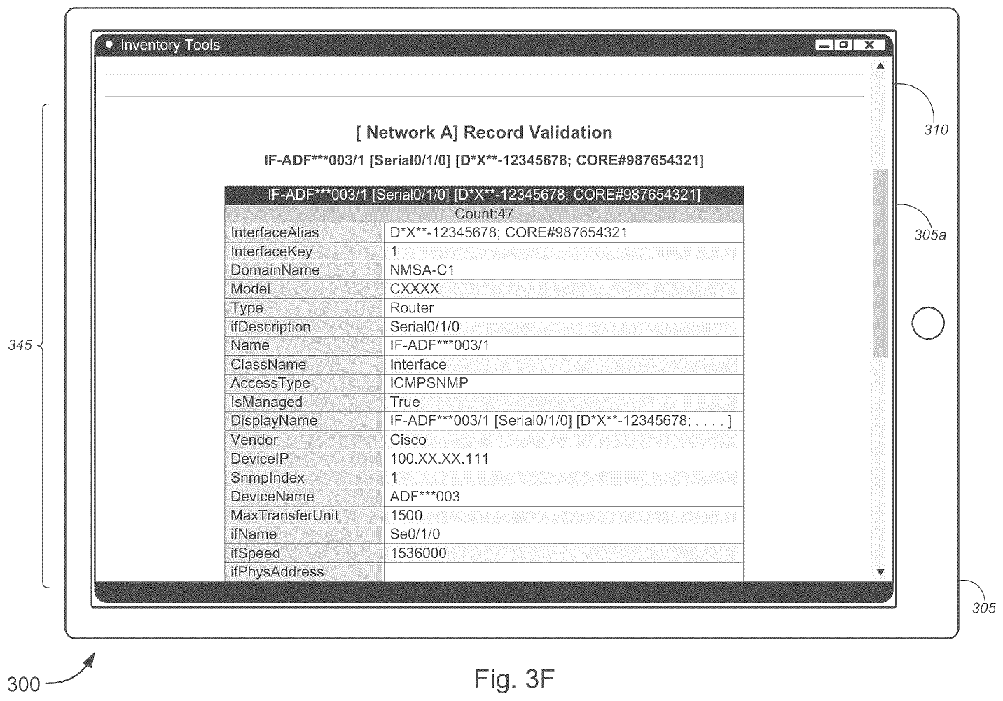

FIGS. 3A-3F (collectively, “FIG. 3”) are diagrams illustrating various non-limiting examples 310 of a user interface (“UI”) that may be presented on a user device used by a user and may be used for searching and validating networks and their components based on data monitored during implementation of GIMS for monitoring network devices for fault management, in accordance with various embodiments.

The embodiment as represented in FIG. 3 is merely illustrative and is not intended to limit the scope of the various embodiments. For example, although a tablet computer is shown as the user device 300, any suitable user device—including, but not limited to, user device(s) 170, which may each include, but is limited to, one of a desktop computer, a laptop computer, a tablet computer, a smart phone, a mobile phone, a NOC computing system or console, or any suitable device capable of communicating with computing system or GIMS 105 (or with GIMS UI 165) via a web-based portal, an API, a server, an app, or any other suitable communications interface, or the like, over network(s) 175, and the like—may be used.

As shown in the embodiment of FIG. 3, user device 300 may comprise a device housing 305 and a display 305a (which may be a touchscreen display or a non-touchscreen display). An app, an application window, program window or portal (e.g., web portal or the like) may be displayed on the display 305a. In the non-limiting example of FIG. 3, the app or portal 310 running on the user device 300 is a user interface illustrating a GIMS UI (in some cases, including “Inventory Tools” or the like), although the various embodiments are not limited to such an app or portal, as described herein, and can be any suitable app or portal. The app or portal 310 displayed in display 305a may provide a user (e.g., a technician, a telephone agent, a web-based agent, a chat agent, or other representative, etc. of the service provider, and/or the user as described above with respect to FIG. 1, or the like) with the ability, functionality, or options to display and customize a graphical representation of groupings of related information associated with the network devices. The app or portal 310 displayed in display 305a may further provide the user with the ability, functionality, or options to search (using a search tool) for devices among the at least one of the plurality of layer 2 devices or the plurality of layer 3 devices, to produce (using a reporting tool) reports associated with one or more devices among the at least one of the plurality of layer 2 devices or the plurality of layer 3 devices, and/or to provide the user with options (using a system monitoring tool) for selecting types of device information and thresholds for monitoring functionality and status of devices among the at least one of the plurality of layer 2 devices or the plurality of layer 3 devices, and/or the like.

As shown in the non-limiting example of FIG. 3A, the app or portal 310 may include, without limitation, at least one of a header portion 315 (e.g., indicating the app or portal site as “Inventory Tools” or the like), a title portion 320 (e.g., indicating the functionality(ies) being offered by the Inventory Tools, in this case, “GIMS Device Validation” or the like), a network list and selection portion 325 (including virtual buttons or options 330 for selecting a particular network among a plurality of disparate networks (similar to network(s) 155 of FIG. 1, or the like; in this case, “Network A,” “Network B,” . . . “Network N,” or the like)), a search portion 335 (including options to search by keyword(s) and/or a virtual button or option 340 to utilize a detailed search (the UI of which is not shown)), or a results portion 345 (indicating the results of an IP query and record validation in response to selecting “Network A” or the like), and/or the like.

FIG. 3B depicts a non-limiting example of “Record Validation” for Network A, with the results of the query listing, e.g., discovery of network clusters C1 through C7, IG1, and IS1, discovery failure of network device clusters C3, C5, and C7, pending query associated with each of network device clusters C1 through C4, ping failure associated with each of network device clusters C1 through C3, and/or the like. The results shown in FIG. 3B are intended to be merely illustrative and do not limit the various embodiments to such a query or to the types of results of such a query. Each listed network device cluster may include a selectable link to display additional information. For instance, selecting network device cluster “IP:DISCOVER:NMSA-C1” (denoted by this item being highlighted in boldface in FIG. 3B, or the like) may result in querying the GIMS UI for information regarding network device cluster “IP:DISCOVER:NMSA-C1.”

In response to querying the GIMS UI for information regarding network device cluster “IP:DISCOVER:NMSA-C1,” the query results (as shown in the non-limiting example of FIG. 3C) would include “Record Validation” for network device cluster “IP:DISCOVER:NMSA-C1,” which may include a list of network devices in the network cluster listed by IP address (such as “100.XX.XX.111,” “100.XX.XX.71,” “100.XX.XX.160,” “100.XX.XX.214,” “100.XX.XX.38,” and “100.XX.XX.254” as shown in FIG. 3C), with information regarding, but not limited to, community strings, SNMP port, device IP address, access mode (e.g., ICMPSNMP or the like), SNMP version (e.g., V1, V2C, V3, or the like; in this case, “V2C”), name of device (in this case, “ADF***003,” “ADF***069,” “ADF***075,” “ADF***083,” “ADF***018,” and “ADF***022” corresponding to “100.XX.XX.111,” “100.XX.XX.71,” “100.XX.XX.160,” “100.XX.XX.214,” “100.XX.XX.38,” “100.XX.XX.254,” and so on, as shown in, e.g., FIG. 3C), and/or the like. In a similar manner as with the listed network device clusters in FIG. 3B, each listed IP address may include a selectable link to display additional information. For instance, selecting IP address “100.XX.XX.111” (denoted by this item being highlighted in boldface in FIG. 3C, or the like) may result in querying the GIMS UI for information regarding IP address “100.XX.XX.111.”

In response to querying the GIMS UI for information regarding IP address “100.XX.XX.111,” the query results (as shown in the non-limiting example of FIG. 3D) would include “IP Query & Record Validation” for IP address “100.XX.XX.111,” which may include a list of network devices or equipment (in some cases including brief descriptions; e.g., “CARD-ADF***003/1 [CXXXX Mother board 3GE, . . . ],” “CARD-ADF***003/2 [4G WWAN . . . ],” “CARD-ADF***003/3 [WAN Interface Card . . . ],” “CARD-ADF***003/4 [4 Port Non-POE EHWIC Switch],” “CARD-ADF***003/5 [ . . . AC Power Supply],” “IP:Cards-100.XX.XX.111,” “ADF***003,” “CARD-ADF***003/1 [Fan Tray],” “CARD-ADF***003/2 [Fan 1],” “CARD-ADF***003/3 [Fan 2],” “CARD-ADF***003/4 [Fan 3],” “IF-ADF***003/1 [Serial0/1/0] [D*X**-12345678; CORE #0987654321],” “IF-ADF***003/10 [GigabitEthernet0/2/3],” “IF-ADF***003/11 [Null0],” “IF-ADF***003/12 [Vlan1],” “IF-ADF***003/13 [Cellular0/0/0],” “IF-ADF***003/16 [Cellular0/0/3],” “IF-ADF***003/17 [GigabitEthernet0/0.3] [EFT],” “IF-ADF***003/18 [GigabitEthernet0/0.7] [Spare],” and so on, as shown in, e.g., FIG. 3D), and/or the like. In a similar manner as with the listed network device clusters in FIG. 3B, each listed network device or equipment may include a selectable link to display additional information. For instance, network device or equipment “ADF***003” or “IF-ADF***003/1 [Serial0/1/0] [D*X**-12345678; CORE #0987654321]” (denoted by these items being highlighted in boldface in FIG. 3D, or the like) may result in querying the GIMS UI for information regarding network device or equipment “ADF***003” and “IF-ADF***003/1 [Serial0/1/0] [D*X**-12345678; CORE #0987654321].”

In response to querying the GIMS UI for information regarding network device or equipment “ADF***003,” the query results (as shown in the non-limiting example of FIG. 3E) would include “Record Validation” for network device or equipment “ADF***003,” which may include a list of fields, including, but not limited to, “DomainName” (in this case, “NMSA-C1” or the like), “USR ProviderPort,” “USR CustomerName,” “ProbeErrorInfo,” “LastUpdatedByPoller,” “PingStatus” (in this case, “GOOD” or the like), “Location,” “USR ProductID,” “DiscoveryTime,” “USR EnterpriseID,” “NumberofPorts” (in this case, “28”), “Description,” “Type” (in this case, “Router”), “USR CDI Status,” “IsManaged” (in this case, “True”), “LastPolledEpoch,” “SystemObjectID,” “SnmpAlarmRaised,” “USR Service,” and so on, as shown in, e.g., FIG. 3E), and/or the like.

In response to querying the GIMS UI for information regarding network device or equipment “IF-ADF***003/1 [Serial0/1/0] [D*X**-12345678; CORE #0987654321],” the query results (as shown in the non-limiting example of FIG. 3F) would include “Record Validation” for network device or equipment “IF-ADF***003/1 [Serial0/1/0] [D*X**-12345678; CORE #0987654321],” which may include a list of fields, including, but not limited to, “InterfaceAlias” (in this case, “D*X**-12345678; CORE #0987654321”), “InterfaceKey” (in this case, “1”), “DomainName” (in this case, “NMSA-C1” or the like), “Model” (in this case, “CXXXX”), “Type” (in this case, “Router”), “ifDescription” (in this case, “Serial0/1/0”), “Name” (in this case, “IF-ADF***003/1”), “ClassName” (in this case, “Interface”), “AccessType” (in this case, “ICMPSNMP”), “IsManaged” (in this case, “True”), “DisplayName” (in this case, “IF-ADF***003/1 [Serial0/1/0] [D*X**-12345678; CORE #0987654321]”), “Vender,” “SnmpIndex” (in this case, “1”), “DeviceName” (in this case, “ADF***003”), “MaxTransferUnit” (in this case, “1500”), “ifName” (in this case, “Se0/1/0”), “ifSpeed,” “ifPhysAddress,” and so on, as shown in, e.g., FIG. 3F), and/or the like.

Herein, “X” and “*” in FIG. 3 represents redacted information, while ellipses (“ . . . ”) represents additional information that is not shown, for the purposes of simplicity of illustration in this patent document, but would be visible to a user during regular use of the GIMS UI (unless otherwise indicated).

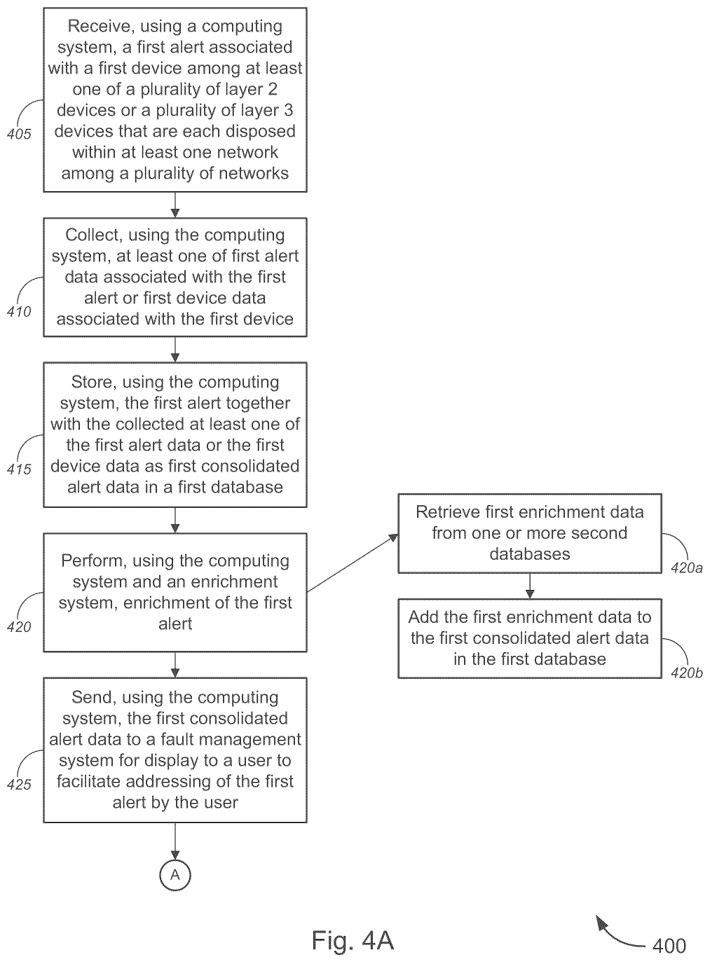

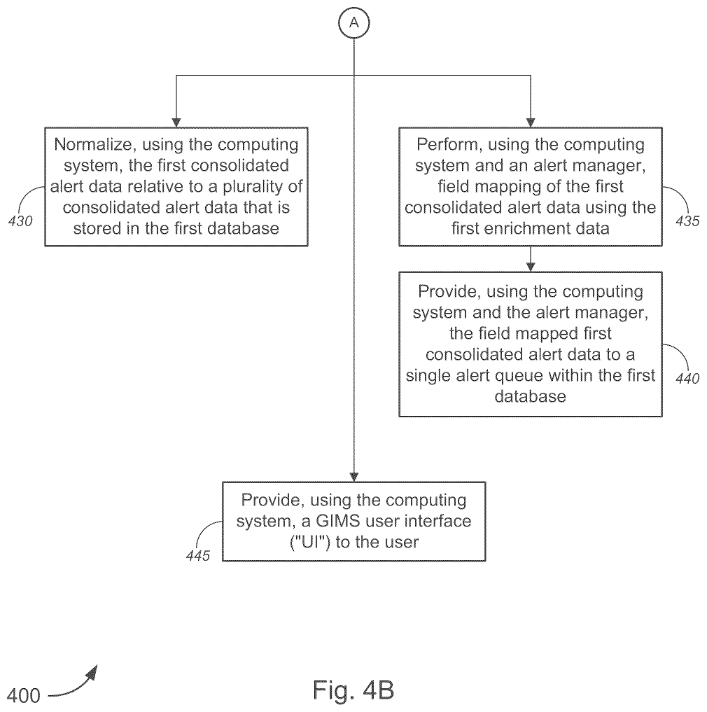

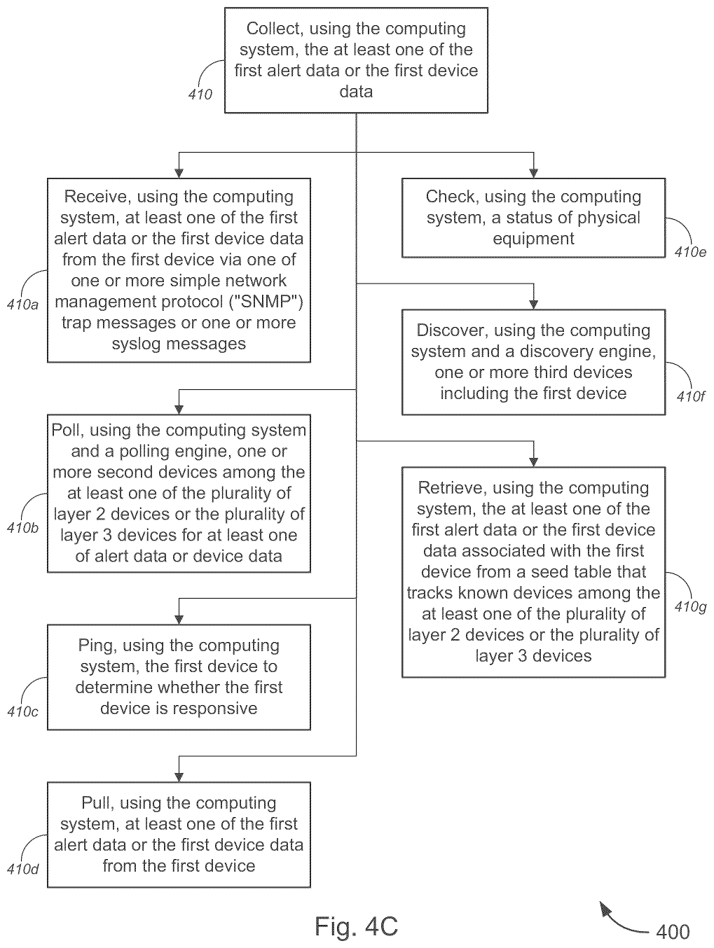

FIGS. 4A-4C (collectively, “FIG. 4”) are flow diagrams illustrating a method 400 for implementing GIMS for monitoring network devices for fault management, in accordance with various embodiments. Method 400 of FIG. 4A continues onto FIG. 4B following the circular marker denoted, “A.”

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems, examples, or embodiments 100, 200, and 310 of FIGS. 1, 2, and 3, respectively (or components thereof), such methods may also be implemented using any suitable hardware (or software) implementation. Similarly, while each of the systems, examples, or embodiments 100, 200, and 310 of FIGS. 1, 2, and 3, respectively (or components thereof), can operate according to the method 400 illustrated by FIG. 4 (e.g., by executing instructions embodied on a computer readable medium), the systems, examples, or embodiments 100, 200, and 310 of FIGS. 1, 2, and 3 can each also operate according to other modes of operation and/or perform other suitable procedures.

In the non-limiting embodiment of FIG. 4A, method 400, at block 405, may comprise receiving, using a computing system, a first alert associated with a first device among at least one of a plurality of layer 2 devices or a plurality of layer 3 devices that are each disposed within at least one network among a plurality of networks, the layer 2 devices and the layer 3 devices corresponding to open systems interconnection (“OSI”) model's data link layer and network layer, respectively.

Method 400 may further comprise collecting, using the computing system, at least one of first alert data associated with the first alert or first device data associated with the first device (block 410); storing, using the computing system, the first alert together with the collected at least one of the first alert data or the first device data as first consolidated alert data in a first database (block 415); and performing, using the computing system and an enrichment system, enrichment of the first alert (block 420), by: retrieving first enrichment data from one or more second databases (block 420a), the first enrichment data comprising at least one of service data associated with a service provided via the first device to a customer, customer data corresponding to the customer associated with the service provided via the first device or associated with the first device, or network data associated with a network in which the first device is disposed; and adding the first enrichment data to the first consolidated alert data in the first database (block 420b). At block 425, method 400 may comprise sending, using the computing system, the first consolidated alert data to a fault management system for display to a user to facilitate addressing of the first alert by the user.

In some embodiments, the computing system may comprise at least one of a global Internet Protocol management system (“GIMS”), the fault management system, a network operations center (“NOC”) computing system, a server over a network, a cloud computing system, or a distributed computing system, and/or the like. In some instances, the plurality of networks may comprise two or more disparate networks utilizing different alert management protocols and different fault management protocols. In some cases, the first database may comprise at least one of a remote dictionary server (“Redis”) database, a non-relational (“NoSQL”) database, or a relational (“SQL”) database, and/or the like. In some instances, the first consolidated alert data may comprise real-time or near-real-time consolidated alert data, and the fault management system may comprise a real-time fault management system (“RFM”) that displays the real-time or near-real-time consolidated alert data.

Method 400 may continue onto one or more of the process at block 430 in FIG. 4B, the process at block 435 in FIG. 4B, or the process at block 445 in FIG. 4B, each following the circular marker denoted, “A.”

At block 430 in FIG. 4B (following the circular marker denoted, “A”), method 400 may comprise normalizing, using the computing system, the first consolidated alert data relative to a plurality of consolidated alert data that is stored in the first database.

Alternatively, or additionally, at block 435 in FIG. 4B (following the circular marker denoted, “A”), method 400 may comprise performing, using the computing system and an alert manager, field mapping of the first consolidated alert data using the first enrichment data; and providing, using the computing system and the alert manager, the field mapped first consolidated alert data to a single alert queue within the first database (block 440).

Alternatively, or additionally, at block 445 in FIG. 4B (following the circular marker denoted, “A”), method 400 may comprise providing, using the computing system, a GIMS user interface (“UI”) to the user. In some cases, the GIMS UI may comprise at least one of a search tool configured to search for devices among the at least one of the plurality of layer 2 devices or the plurality of layer 3 devices, a reporting tool configured to produce reports associated with one or more devices among the at least one of the plurality of layer 2 devices or the plurality of layer 3 devices, or a system monitoring tool configured to provide the user with options for selecting types of device information and thresholds for monitoring functionality and status of devices among the at least one of the plurality of layer 2 devices or the plurality of layer 3 devices, and/or the like.

Referring to the non-limiting embodiment of FIG. 4C, collecting the at least one of the first alert data or the first device data (at block 410) may comprise at least one of: receiving, using the computing system, at least one of the first alert data or the first device data from the first device via one of one or more simple network management protocol (“SNMP”) trap messages or one or more system logging protocol (“Syslog”) messages (block 410a), both the trap messages and the Syslog messages being asynchronous notifications; polling, using the computing system and a polling engine, one or more second devices among the at least one of the plurality of layer 2 devices or the plurality of layer 3 devices for at least one of alert data or device data, the one or more second devices including the first device (block 410b); pinging, using the computing system, the first device to determine whether the first device is responsive, wherein the first alert data comprises data indicating when the first device is not responsive, wherein the first device data comprises data corresponding to responsiveness or lack of responsiveness of the first device (block 410c); pulling, using the computing system, at least one of the first alert data or the first device data from the first device (block 410d); checking, using the computing system, a status of physical equipment (block 410e); discovering, using the computing system and a discovery engine, one or more third devices including the first device (block 410f); or retrieving, using the computing system, the at least one of the first alert data or the first device data associated with the first device from a seed table that tracks known devices among the at least one of the plurality of layer 2 devices or the plurality of layer 3 devices (block 410g); and/or the like.

In some instances, the one or more SNMP trap messages may be processed, modified, or deleted by a SNMP manager, based on first independent rules associated with the network in which the first device is disposed, prior to storing the first alert in the first database. Similarly, the one or more Syslog messages may be processed, modified, or deleted by a Syslog server, based on second independent rules associated with the network in which the first device is disposed, prior to storing the first alert in the first database.

In some cases, the status of physical equipment may include, without limitation, at least one of status data indicating that the first device is not functioning within predetermined device parameters, status data indicating that a fan or other cooling device at the location of the first device is not functioning within predetermined cooling parameters, status data indicating that an interface is not functioning within predetermined interface parameters, status data indicating that a power supply is not functioning within predetermined power supply parameters, or status data flagging one or more errored seconds indicative of one or more intervals of a second during which an error occurred, and/or the like.

In some instances, discovering the one or more third devices comprises receiving at least one of alert data or device data from each of the one or more third devices.

### Exemplary System and Hardware Implementation

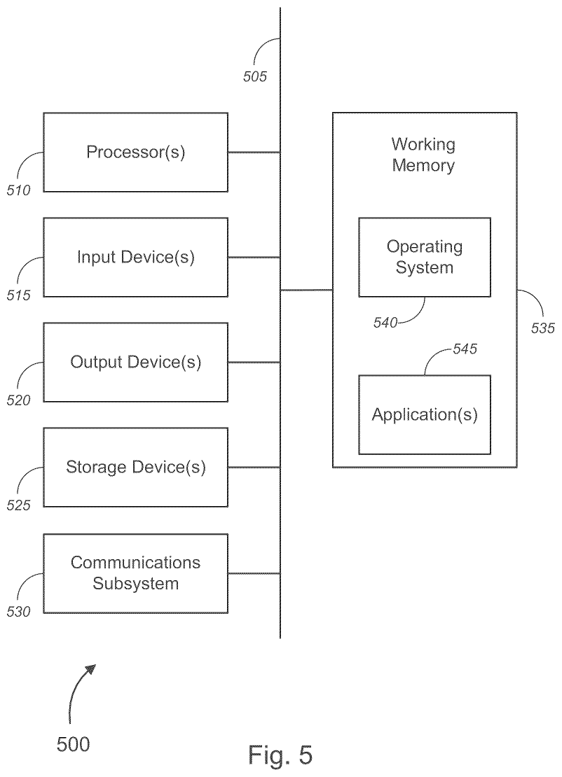

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing system or global Internet Protocol management system (“GIMS”) 105, simple network management protocol (“SNMP”) manager 115, system logging protocol (“Syslog”) server 120, alert manager 125, polling engine 130, discovery engine 135, seed processor 140, enrichment system 145, network devices 155a-155n, real-time fault management system (“RFM”) 160, and user devices 170a-170n, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing system or GIMS 105, SNMP manager 115, Syslog server 120, alert manager 125, polling engine 130, discovery engine 135, seed processor 140, enrichment system 145, network devices 155a-155n, RFM 155, and user devices 170a-170n, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like. In some embodiments, some of these computer or hardware systems may be implemented as virtual devices or software-based systems running on hardware comprising one or more of the hardware elements shown in FIG. 5.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication sub system 530 (and/or the media by which the communications sub system 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, using a computing system, a first alert associated with a first device among at least one of a plurality of layer 2 devices or a plurality of layer 3 devices that are each disposed within at least one network among a plurality of networks, the layer 2 devices and the layer 3 devices corresponding to open systems interconnection (“OSI”) model's data link layer and network layer, respectively;
collecting, using the computing system, at least one of first alert data associated with the first alert or first device data associated with the first device;
storing, using the computing system, the first alert together with the collected at least one of the first alert data or the first device data as first consolidated alert data stored in a first database;
performing, using the computing system and an enrichment system, enrichment of the first alert, by:
retrieving first enrichment data from one or more second databases, the first enrichment data comprising at least one of service data associated with a service provided via the first device to a customer, customer data corresponding to the customer associated with the service provided via the first device or associated with the first device, or network data associated with a network in which the first device is disposed; and
adding the first enrichment data to the first consolidated alert data in the first database; and
sending, using the computing system, the first consolidated alert data to a fault management system for display to a user to facilitate addressing of the first alert by the user.

2. The method of claim 1, wherein the computing system comprises at least one of a global Internet Protocol management system (“GIMS”), the fault management system, a network operations center (“NOC”) computing system, a server over a network, a cloud computing system, or a distributed computing system.

3. The method of claim 1, wherein the plurality of networks comprises two or more disparate networks utilizing different alert management protocols and different fault management protocols.

4. The method of claim 1, wherein the first database comprises at least one of a remote dictionary server (“Redis”) database, a non-relational (“NoSQL”) database, or a relational (“SQL”) database.

5. The method of claim 1, wherein the first consolidated alert data comprises real-time or near-real-time consolidated alert data, wherein the fault management system comprises a real-time fault management system (“RFM”) that displays the real-time or near-real-time consolidated alert data.

6. The method of claim 1, wherein collecting the at least one of the first alert data or the first device data comprises at least one of:
receiving, using the computing system, at least one of the first alert data or the first device data from the first device via one of one or more simple network management protocol (“SNMP”) trap messages or one or more system logging protocol (“Syslog”) messages;
polling, using the computing system and a polling engine, one or more second devices among the at least one of the plurality of layer 2 devices or the plurality of layer 3 devices for at least one of alert data or device data, the one or more second devices including the first device;
pinging, using the computing system, the first device to determine whether the first device is responsive, wherein the first alert data comprises data indicating when the first device is not responsive, wherein the first device data comprises data corresponding to responsiveness or lack of responsiveness of the first device;
pulling, using the computing system, at least one of the first alert data or the first device data from the first device;
checking, using the computing system, a status of physical equipment, the status of physical equipment comprising at least one of status data indicating that the first device is not functioning within predetermined device parameters, status data indicating that a fan or other cooling device at the location of the first device is not functioning within predetermined cooling parameters, status data indicating that an interface is not functioning within predetermined interface parameters, status data indicating that a power supply is not functioning within predetermined power supply parameters, or status data flagging one or more errored seconds indicative of one or more intervals of a second during which an error occurred;
discovering, using the computing system and a discovery engine, one or more third devices including the first device, wherein discovering the one or more third devices comprises receiving at least one of alert data or device data from each of the one or more third devices; or
retrieving, using the computing system, the at least one of the first alert data or the first device data associated with the first device from a seed table that tracks known devices among the at least one of the plurality of layer 2 devices or the plurality of layer 3 devices.

7. The method of claim 6, wherein:
the one or more SNMP trap messages are processed, modified, or deleted by a SNMP manager, based on first independent rules associated with the network in which the first device is disposed, prior to storing the first alert in the first database; and
the one or more Syslog messages are processed, modified, or deleted by a Syslog server, based on second independent rules associated with the network in which the first device is disposed, prior to storing the first alert in the first database.

8. The method of claim 1, further comprising:
normalizing, using the computing system, the first consolidated alert data relative to a plurality of consolidated alert data that is stored in the first database.

9. The method of claim 1, further comprising:
performing, using the computing system and an alert manager, field mapping of the first consolidated alert data using the first enrichment data; and
providing, using the computing system and the alert manager, the field mapped first consolidated alert data to a single alert queue within the first database.

10. The method of claim 1, further comprising:
providing, using the computing system, a GIMS user interface (“UI”) to the user, the GIMS UI comprising at least one of a search tool configured to search for devices among the at least one of the plurality of layer 2 devices or the plurality of layer 3 devices, a reporting tool configured to produce reports associated with one or more devices among the at least one of the plurality of layer 2 devices or the plurality of layer 3 devices, or a system monitoring tool configured to provide the user with options for selecting types of device information and thresholds for monitoring functionality and status of devices among the at least one of the plurality of layer 2 devices or the plurality of layer 3 devices.

11. A system, comprising:
a computing system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
receive a first alert associated with a first device among at least one of a plurality of layer 2 devices or a plurality of layer 3 devices that are each disposed within at least one network among a plurality of networks, the layer 2 devices and the layer 3 devices corresponding to open systems interconnection (“OSI”) model's data link layer and network layer, respectively;
collect at least one of first alert data associated with the first alert or first device data associated with the first device;
store the first alert together with the collected at least one of the first alert data or the first device data as first consolidated alert data in a first database;
perform, using an enrichment system, enrichment of the first alert, by:
retrieving first enrichment data from one or more second databases, the first enrichment data comprising at least one of service data associated with a service provided via the first device to a customer, customer data corresponding to the customer associated with the service provided via the first device or associated with the first device, or network data associated with a network in which the first device is disposed; and
adding the first enrichment data to the first consolidated alert data in the first database; and
send the first consolidated alert data to a fault management system for display to a user to facilitate addressing of the first alert by the user.

12. The system of claim 11, wherein the computing system comprises at least one of a global Internet Protocol management system (“GIMS”), the fault management system, a network operations center (“NOC”) computing system, a server over a network, a cloud computing system, or a distributed computing system.

13. The system of claim 11, wherein the plurality of networks comprises two or more disparate networks utilizing different alert management protocols and different fault management protocols.

14. The system of claim 11, wherein the first database comprises at least one of a remote dictionary server (“Redis”) database, a non-relational (“NoSQL”) database, or a relational (“SQL”) database, wherein the first consolidated alert data comprises real-time or near-real-time consolidated alert data, wherein the fault management system comprises a real-time fault management system (“RFM”) that displays the real-time or near-real-time consolidated alert data.

15. The system of claim 11, wherein collecting the at least one of the first alert data or the first device data comprises at least one of:
receiving at least one of the first alert data or the first device data from the first device via one of one or more simple network management protocol (“SNMP”) trap messages or one or more system logging protocol (“Syslog”) messages;
polling, using a polling engine, one or more second devices among the at least one of the plurality of layer 2 devices or the plurality of layer 3 devices for at least one of alert data or device data, the one or more second devices including the first device;
pinging the first device to determine whether the first device is responsive, wherein the first alert data comprises data indicating when the first device is not responsive, wherein the first device data comprises data corresponding to responsiveness or lack of responsiveness of the first device;
pulling at least one of the first alert data or the first device data from the first device;
checking a status of physical equipment, the status of physical equipment comprising at least one of status data indicating that the first device is not functioning within predetermined device parameters, status data indicating that a fan or other cooling device at the location of the first device is not functioning within predetermined cooling parameters, status data indicating that an interface is not functioning within predetermined interface parameters, status data indicating that a power supply is not functioning within predetermined power supply parameters, or status data flagging one or more errored seconds indicative of one or more intervals of a second during which an error occurred;
discovering, using a discovery engine, one or more third devices including the first device, wherein discovering the one or more third devices comprises receiving at least one of alert data or device data from each of the one or more third devices; or
retrieving the at least one of the first alert data or the first device data associated with the first device from a seed table that tracks known devices among the at least one of the plurality of layer 2 devices or the plurality of layer 3 devices.

16. The system of claim 15, wherein:
the one or more SNMP trap messages are processed, modified, or deleted by a SNMP manager, based on first independent rules associated with the network in which the first device is disposed, prior to storing the first alert in the first database; and
the one or more Syslog messages are processed, modified, or deleted by a Syslog server, based on second independent rules associated with the network in which the first device is disposed, prior to storing the first alert in the first database.

17. The system of claim 11, wherein the first set of instructions, when executed by the at least one first processor, further causes the computing system to:
normalize the first consolidated alert data relative to a plurality of consolidated alert data that is stored in the first database.

18. The system of claim 11, wherein the first set of instructions, when executed by the at least one first processor, further causes the computing system to:
perform, using an alert manager, field mapping of the first consolidated alert data using the first enrichment data; and
provide, using the alert manager, the field mapped first consolidated alert data to a single alert queue within the first database.

19. The system of claim 11, wherein the first set of instructions, when executed by the at least one first processor, further causes the computing system to:
provide a GIMS user interface (“UI”) to the user, the GIMS UI comprising at least one of a search tool configured to search for devices among the at least one of the plurality of layer 2 devices or the plurality of layer 3 devices, a reporting tool configured to produce reports associated with one or more devices among the at least one of the plurality of layer 2 devices or the plurality of layer 3 devices, or a system monitoring tool configured to provide the user with options for selecting types of device information and thresholds for monitoring functionality and status of devices among the at least one of the plurality of layer 2 devices or the plurality of layer 3 devices.

20. A system, comprising:
a global Internet Protocol management system (“GIMS”), comprising:
a simple network management protocol (“SNMP”) manager configured to receive SNMP trap messages from network devices;
a system logging protocol (“Syslog”) server configured to receive Syslog messages from network devices;
an alert manager configured to manage alerts associated with network devices;
at least one of a polling engine, a discovery engine, or a seed processor, the polling engine being configured to poll network devices for at least one of alert data or device data, the discovery engine being configured to discover currently active or currently connected network devices on one or more networks, and the seed processor being configured to track network devices in the one or more networks; and
an enrichment system configured to retrieve enrichment data from one or more second databases and to add enrichment data to consolidated alert data;
wherein one or more of the GIMS, the SNMP manager, the Syslog server, the alert manager, or the at least one of the polling engine, the discovery engine, or the seed processor is configured or further configured to:
receive a first alert associated with a first device among at least one of a plurality of layer 2 devices or a plurality of layer 3 devices that are each disposed within at least one network among the one or more networks, the layer 2 devices and the layer 3 devices corresponding to open systems interconnection (“OSI”) model's data link layer and network layer, respectively;
collect at least one of first alert data associated with the first alert or first device data associated with the first device; and
store the first alert together with the collected at least one of the first alert data or the first device data as first consolidated alert data in a first database;
wherein the enrichment system is further configured to perform enrichment of the first alert, by:
retrieving first enrichment data from one or more second databases, the first enrichment data comprising at least one of service data associated with a service provided via the first device to a customer, customer data corresponding to the customer associated with the service provided via the first device or associated with the first device, or network data associated with a network in which the first device is disposed; and
adding the first enrichment data to the first consolidated alert data in the first database; and
wherein at least one of the GIMS or the alert manager is further configured to:
send the first consolidated alert data to a fault management system for display to a user to facilitate addressing of the first alert by the user.
